(19) United States
(12) Patent Application Publication
(10) Pub. No.: US 2008/0142526 A1
(43) Pub. Date: Jun. 19, 2008

(54) Induction Cookware

(75) Inventors: Stanley Kin Sui Cheng, Vallejo, CA (US); Mang Hung Chan, Chonburi (TH)

Correspondence Address: MEYER CORPORATION, U.S.;ATTN: EDWARD S. SHERMAN, ESQ., ONE MEYER PLAZA, VALLEJO, CA, 94590, US

(73) Assignee: MEYER INTELLECTUAL PROPERTIES LIMITED, Hong Kong (CN)

(21) Appl. No.: 11/612,676

(22) Filed: Dec. 19, 2006

(51) Int. Cl. A47J 27/00; A47J 36/00

(52) U.S. Cl. 220/573.1; 220/573.2

(57) ABSTRACT

A cookware vessel is formed primarily of an aluminum shell. The bottom of the shell has a thick layer of a thermally conductive material, such as copper and/or additional aluminum, to build up a plate. A surrounding cap, preferably made of or containing ferromagnetic materials, such as stainless steel, in turn protects this plate. The exterior surface is coated with an exterior protective, and preferably non-stick coating. This coating itself is protected from overheating by the thermally conductive material and the cap structure. In more preferred embodiments, the aluminum shell is anodized such that with the exterior protective coating it is safe to clean the cookware vessel in a dishwasher with all types of detergents. The cookware vessel may be used with conventional flame or electric heating element stovetops, as well as induction cooking ranges.

### CROSS REFERENCE TO RELATED APPLICATIONS

None

### BACKGROUND OF INVENTION

The present invention relates to cookware vessels and in particular to aluminum cookware suitable for use with induction cooking methods.

Cookware vessels have been fabricated from a variety metals, including laminations of different metals to provide selected improvements in at least one of strength, thermal conductivity, weight, and durability among other properties, without detriment to the other properties.

Induction cooking is now in common use and gaining in popularity because it is fast, energy efficient and safer, in that the cook is not exposed to an open flame or hot electric heating element. For induction cooking a usually ferromagnetic or ferromagnetic-coated cookware vessel is placed on top of a support surface on the range or stovetop. The supporting surface usually consists of plate of dielectric material, such as glass or glass-ceramic. An induction coil disposed beneath the support surface is in effect the heating element. The induction heating element is a conductive electric coil usually sealed and isolated from the support surface of the cookware. The AC current in the coil produces eddy currents within the ferromagnetic material in the cookware vessel. These eddy currents within the ferromagnetic portion of the cookware vessel create heat from the resistance of the metal because of induction. This heats the remainder of cookware vessel, but no heat is generated from the actual range or stovetop. Various US patents teach the desirability of particular materials and constructions that include one or more metals that act as a receiver of the energy from the coil, with other materials of construction improving heat transfer or to impart other physical properties to the cookware vessel. These include U.S. Pat. No. 3,966,426 to McCoy, et al. (issued Jul. 29, 1976); U.S. Pat. No. 4,544,818 to Minamida (issued Oct. 1, 1985); U.S. Pat. No. 4,646,935 to Ulam (issued Mar. 3, 1987); U.S. Pat. No. 4,705,727 to Hunter (issued Nov. 10, 1987); U.S. Pat. No. 5,952,112 to Spring (issued Sep. 14, 1999) and U.S. Pat. No. 6,926,971 to Groll (issued Aug. 9, 2005), all of which are incorporated herein by reference.

Aluminum cookware, and in particular anodized aluminum cookware, has become popular because it is light in weight, compared to steel or iron cookware. The anodized finish provides an alumina or ceramic like aluminum oxide coating that is harder and hence more scratch resistant that the unprotected aluminum metal. However, aluminum cookware has several disadvantages. As aluminum is not ferromagnetic, it cannot be used alone on induction cooking ranges. Although the alumina that forms the anodized finish is hard it has inherent chemical properties, which under certain circumstances, can lead to disadvantages for some consumers. For example, an anodized aluminum finish stains more readily from acidic foods than other cookware finishes. Such stains or attacks to the hard alumina coating are more visible on the surrounding black or grey matte surface. Further, it can be more difficult to clean cooking residue that would not even stain the anodized aluminum in comparison to other cookware finishes. In addition, all types of anodized aluminum are susceptible to damage and staining from some type of dishwasher detergent, which being highly alkaline will react with the alumina coating. Non-stick organic coatings have been used on the interior of hard-anodized aluminum cookware. Various US patents teach compositions of matter and methods of applying organic based and non-stick coatings to cookware vessels. These include U.S. Pat. No. 3,986,993 to Vassiliou (issued Oct.-19-1976); U.S. Pat. No. 4,118,537 to Vary, et al. (issued Oct. 3, 1978); U.S. Pat. No. 4,321,177 to Wilkinson (issued Mar. 23, 1982); U.S. Pat. No. 5,691,067 to Patel (issued Oct. 25, 1997) and U.S. Pat. No. 6,133,359 to Bate, et al. (issued Oct. 17, 2000), all of which are incorporated herein by reference.

While organic based and non-stick coatings on the interior of anodized aluminum cookware will provide resistance to attack by dishwasher detergents, the exterior anodized surface will remain susceptible to attack and staining. In fact, from an aesthetic standpoint staining on the exterior of the cookware may be more of a problem for some consumers than staining of an otherwise functional interior cookware surface.

Although numerous patents disclose various methods of attaching or embedding at least a portion of a ferromagnetic layer at the bottom of a cookware article, none is truly compatible for use with anodized aluminum cookware.

It is a general objective of the present invention to provide improved lightweight aluminum cookware compatible with induction ranges.

Another object of the invention to provide a method and process for applying a stainless steel cap to the bottom of anodized aluminum cookware.

It is another object of the invention to provide such anodized aluminum cookware that it safe to clean in dishwashers with any variety of detergent.

### SUMMARY OF INVENTION

It would be desirable to have anodized aluminum cookware that could be used on induction stoves. Anodized cookware has a hard surface and is thus more durable and scratch resistant than metal cookware. Further, anodized cookware having a harder surface, results in greater durability of any non-stick coating used on the interior. However, prior to the current invention anodized cookware is generally not cleanable in automatic dishwashers unless certain detergents are used. It would be desirable to utilize an organic non-stick coating on the exterior, as well as the interior of anodized aluminum cookware to provide for easier clean up and protect the anodized coating from dishwasher detergents. However, the currently known and available non-stick coatings could be damaged by the heat inherent in the cooking process if used on the exterior surface of prior art cookware.

In the present invention, the above and other deficiencies in the prior art are overcome by providing an aluminum article of cookware wherein a principle thermal mass for heat transfer to the foodstuffs is situated between the inside and the outside bottom of the cookware article, being surrounded preferably by a stainless steel cap. The cap comprises at least one ferromagnetic material and is affixed to the aluminum cookware vessel such that it can be used on an induction cooking range. The cap, usually stainless steel, is laminated to the bottom of an aluminum shell to incorporate a thick plate of a thermally conductive material and form the cookware vessel. This thick plate then acts as the principle thermal mass. In particular, the stainless steel cap acts as a resting base for the cookware vessel as it surrounds this now embedded thermal mass. The stainless steel construction of the cap provides the inherent advantage that it is easy to clean and does not stain, and hence will not need the non-stick coating that protects other portions of the cookware article. Thus, an organic non-stick coating can be used to protect the otherwise exposed exterior anodized finish of an aluminum cookware article from staining and chemical attack, rendering it easier to clean. This construction limits the potential for the undesirable overheating of exterior surface that might be protected by an organic coating, such as a non-stick coating.

Further, when the interior and exterior surfaces of the aluminum portions of the cookware are also anodized, the organic coatings protect the anodized finish from attack by dishwasher detergents, thus rendering the cookware both suitable for induction cooking and dishwasher cleaning.

The above and other objects, effects, features, and advantages of the present invention will become more apparent from the following description of the embodiments thereof taken in conjunction with the accompanying drawings.

### BRIEF DESCRIPTION OF THE DRAWINGS

FIG. 1 is a cross-sectional elevation showing a first embodiment of the invention.

FIG. 2 is a cross-sectional elevation showing a second embodiment of the invention.

FIG. 3 is a cross-sectional elevation showing a third embodiment of the invention.

FIG. 4 is a cross-sectional elevation showing a fourth embodiment of the invention.

FIG. 5 is a cross-sectional elevation showing a fifth embodiment of the invention.

### DETAILED DESCRIPTION

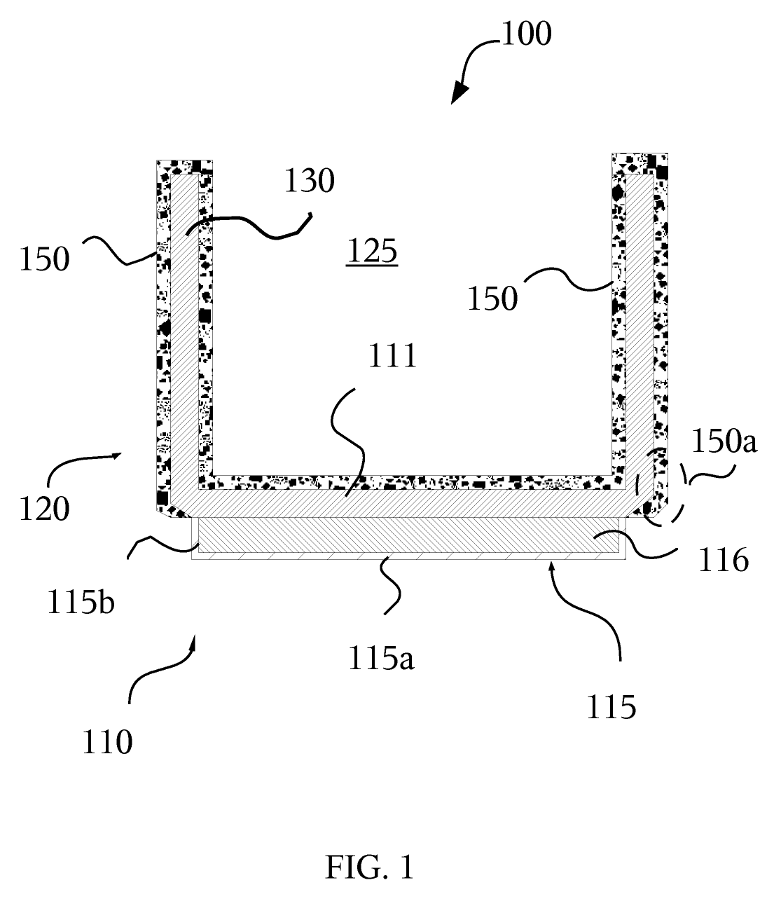

Referring to FIGS. 1 through 5, wherein like reference numerals refer to like components in the various views, there are illustrated therein new and improved aluminum cookware vessels for induction cooking, generally denominated 100 herein. It is to be understood that the relative size, shape and thickness of the components shown in these drawing are not intended to represent the actual configurations, but rather are to simplify the drawings to provide a better understanding of the invention.

In accordance with the present invention, the article of cookware 100 is a fluid containing cooking vessel having a bottom portion 110 surrounded by substantially vertically extending sidewalls 120 to define a fluid retaining interior cavity 125. In this first embodiment of FIG. 1 the outer bottom surface of the article of cookware 100 has a steel cap 115. The steel cap encloses at least one layer of thermally conductive material 116.

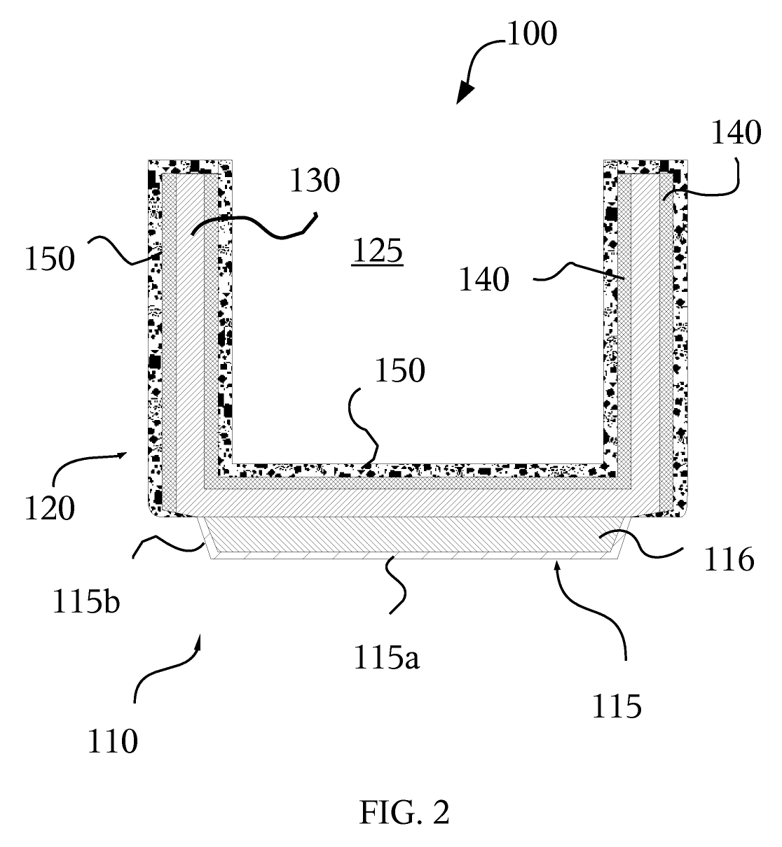

The steel cap 115 has a bottom horizontal surface 115a and relatively short upward extending side surfaces 115b that surrounds the thermally conductive material 116. The steel cap is preferably stainless steel having a thickness of about 0.5 to 1.0 mm. It should be appreciated that while stainless steel is preferred for its corrosion resistance, ferromagnetic grades are more preferred as they act as a receptor for induction cooking. Thus, other metals and alloys with similar properties may be substituted. Thus, to the extent that the material used to form cap 115 is not stainless steel, or a combination of stainless steel and other materials, the preferred thickness may differ to optimize the effectiveness as a receptor of energy in induction cooking. The steel cap 115 may have beveled side surfaces 115b, as shown in FIG. 2, or substantially vertical side surfaces as shown in the other figures, as well as other side profile shapes. The height or depth of the steel cap 115 is sufficient to contain the thermally conductive material 116. The optimum dimensions of the thermally conductive material(s) are selected relative to the other dimensions of the cookware article so that it acts as the principle thermal mass, drawing heat from or through the cap to the fluid retaining interior cavity and the foodstuffs contained therein. Thus, optimizing the dimension of the thermally conductive materials prevents excess heating of the exterior portion of the sidewalls 120 adjacent cap 115.

Further, the article of cookware 100 in FIG. 1, as well as other embodiments, also has an organic coating, but preferably a non-stick coating, 150 covering the exposed surfaces of aluminum shell 130 to facilitate clean up after use. The potential for overheating, and thus degrading, the non-stick coating on the exterior of the cookware article 100 is greatly reduced due to the inclusion of the thermally conductive layer 116 that is surrounded by the steel cap 115. When the steel cap 115 is heated by the induction element, the thermally conductive material 116 preferentially draws the heat into the interior bottom 111 (warming the food stuffs contained therein) minimizing the heating of the sidewalls portion 120 that are covered with the non-stick coating 150a that is adjacent to the steel cap 115. Further, it should be appreciated that even if the non-stick coating could survive the cooking temperature that the bottom of the cookware article is exposed to, it is still preferable to deploy a stainless steel cap on the bottom. While a protective coating might be easily scratched off a bottom surface from the repeated abrasion with a cooking element burner or grid like support, the stainless steel cap needs no such protective coating as it is inherently resistant to dishwashing detergents.

In the preferred embodiments of the invention, the thermally conductive material 116 consists substantially of at least one of copper or aluminum, as well as a combination of these materials as either an alloy or a plurality of different layers. When aluminum is used as the thermally conductive material 116 the thickness is preferably from about 1 mm to about 10 mm, but more preferably at least about 2 mm, while also being generally less than about 7 mm.

The fluid containing portion of cookware vessel 100 is a prefabricated aluminum shell 130 having a bottom portion surrounded by substantially vertically extending sidewalls. The thickness of the aluminum that comprises shell 130 is preferably from about 2 mm to about 5 mm. It will be appreciated that when an aluminum plate is used to form the principle thermal mass 116, the aluminum plate is preferably least as thick as the aluminum that comprises the shell 130 such that the ratio of the total bottom thickness (i.e. the aluminum shell thickness plus the plate thickness) is at least two times the aluminum wall thickness. It is more preferable that the ratio of the total bottom thickness is at least three times the wall thickness.

A preferred method of fabricating the combination of the aluminum shell 130 having thermally conductive bottom layer 116 that is covered with a steel cap 115 is disclosed in GB Patent Application No. 9800516.8, published Jul. 14, 1999, which is incorporated herein by reference. The thermally conductive material 116 is prefabricated to conform substantially to the diameter of the bottom of the preformed aluminum cookware vessel 130. The steel cap 115 is initially a round flat disc that is joined to the aluminum shell 130 as the plate of thermally conductive material 116 is laminated between them. Such lamination preferably occurs in a single step of impact bonding, wherein the impact bonding die deforms the edges of the plate to form side 115b. When the plate is aluminum, the components are heated to a temperature of about 450° C. prior to the single impact used to bond them into an integral unit. Alternatively, the structures in FIG. 1-5 may be laminated together in multiple steps, which may include at least one brazing operation.

Alternatively, the cap 115 can be formed of a 2-play cladding of stainless steel and aluminum sheet. Such a cladding material can be cut into a round sheet and then deformed into a cap shape, i.e. having a slightly upright wall to receive the aluminum pan bottom. It should be appreciated that it is preferable to use a ferromagnetic grade of stainless steel for such cladding so that the cookware is suitable for induction cooking, however other ferromagnetic alloys may be suitable for use as the cladding or included within the bottom assembly of the thermally conductive material 116 with or without a cap 115.

FIG. 2 is a second embodiment of the invention in which the exposed outer surfaces of the aluminum shell 130 have an anodized aluminum coating or finish 140 consisting substantially of aluminum oxide or alumina. The organic non-stick coating 150 covers the anodized aluminum finishes 140.

The anodizing process that forms alumina layer 140 can be carried out before the bonding or lamination process described above, provided the portion of the aluminum vessel 130 that bonds with the thermally conductive material is masked to prevent its anodizing before lamination. Alternatively, the anodizing process that forms alumina layer 140 may be conducted after the lamination process described with respect to FIG. 2, provided the steel cap 116 is to be masked to prevent its degradation in the acid anodizing bath.

The non-stick coating 150 not only facilitates clean up after use but protects the anodized finish from dishwasher detergents. The potential for overheating, and thus degrading, the non-stick finish on the exterior of the cookware article 100 is greatly reduced due to the inclusion of the thermally conductive layer 116 that is surrounded by the steel cap 115. When the steel cap 115 is heated by the induction element, the thermally conductive material 116 preferentially draws the heat into the interior bottom 111 (warming the food stuffs contained therein) minimizing the heating of the sidewalls portion 120 that are covered with the non-stick coating 150 and adjacent the steel cap 115.

It should also be appreciated that the cap also effectively raises the lower edge of sidewall 120 upward away from the electric burn element of flame during cooking this minimizing the direct heating there from.

The non-stick coating 150 is preferably applied to the cookware article 100 after the process of fabrication that includes the bonding of the thermally conductive element 116 and the steel cap 115. The steel cap 115 is masked to prevent its coating with the non-stick finish. Non-stick coatings include fluorocarbon based polymers, as well siloxane based polymers, such as a silicon polyester resin. Suitable fluorocarbon polymers may include PTFE (Polytetrafluoroethylene), FEP (Fluorinated Ethylene Propylene), and PFA (Perfluoroalkoxy). Such polymers are generally applied as multiple coating layers of which at least some contain inorganic filler for reinforcement.

It should be appreciated by one of ordinary skill in the art that the cap 115 and thermally conductive material 116 can be other materials and constructions, although it is preferred that at least one of the cap and the thermally conductive be or include a layer of a magnetic material for the broadest compatibility with induction range tops.

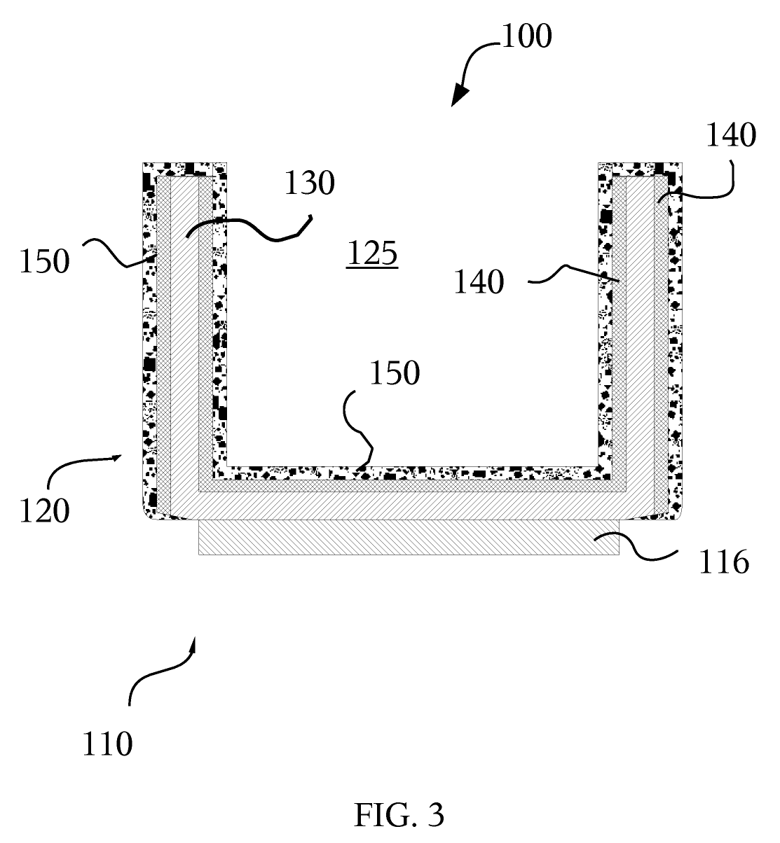

For example, FIG. 3 shows an alternative embodiment of the invention in which the steel cap does not surround the thermally conductive material 116.

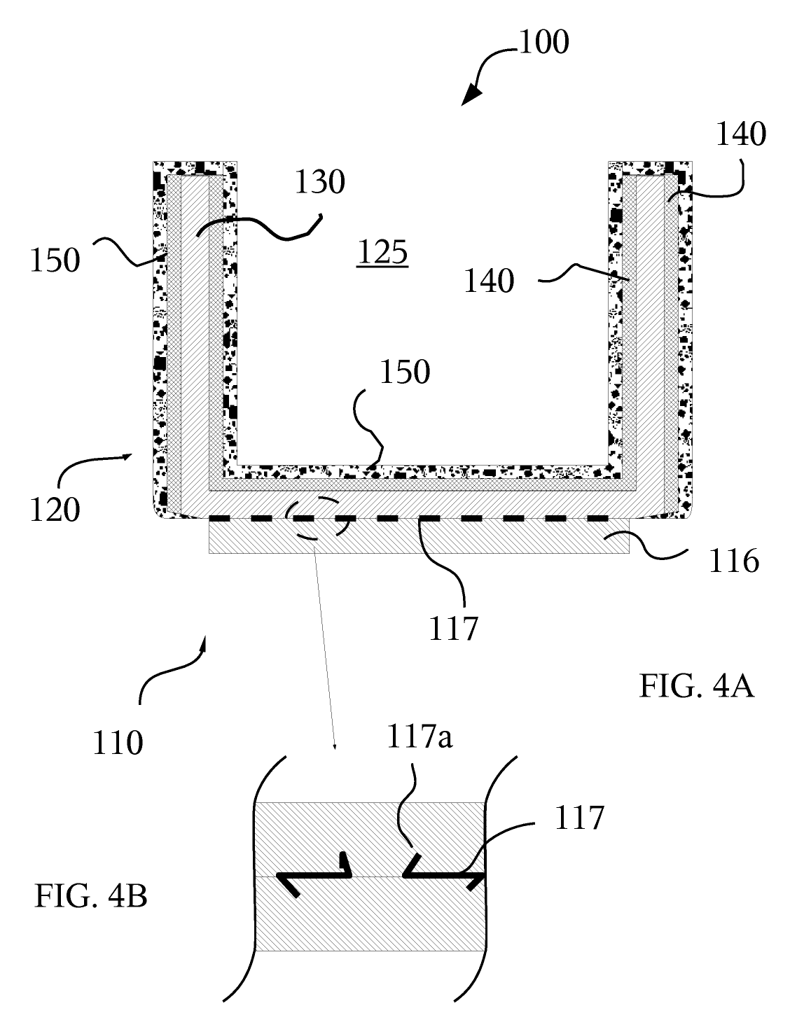

FIG. 4A shows another alternative embodiment of the invention in which the steel cap does not surround the thermally conductive material 116, but at least one layer 117 of a magnetic material or alloy, such as stainless steel, is bonded to both the bottom of shell 130 and thermally conductive material 116. In this embodiment layer 117 is a perforated sheet or grate such that the aluminum from the shell and the plate 116 surrounded by the cap 115 readily bond together. Such a grate optionally includes perforated metal portions that extend upward and downward from alternating holes so as to mechanically lock into the softer aluminum metal during bonding at lower temperatures. Such a structure of the grate 117 is illustrated in FIG. 4B. Each hole or opening in the grating preferably has an attached sharp punched protrusion 117a that initially points normal to the grating but folds inward to penetrate the adjacent aluminum layers 116 and 115, cause a mechanically locking therein as the aluminum deforms to accommodate the penetration.

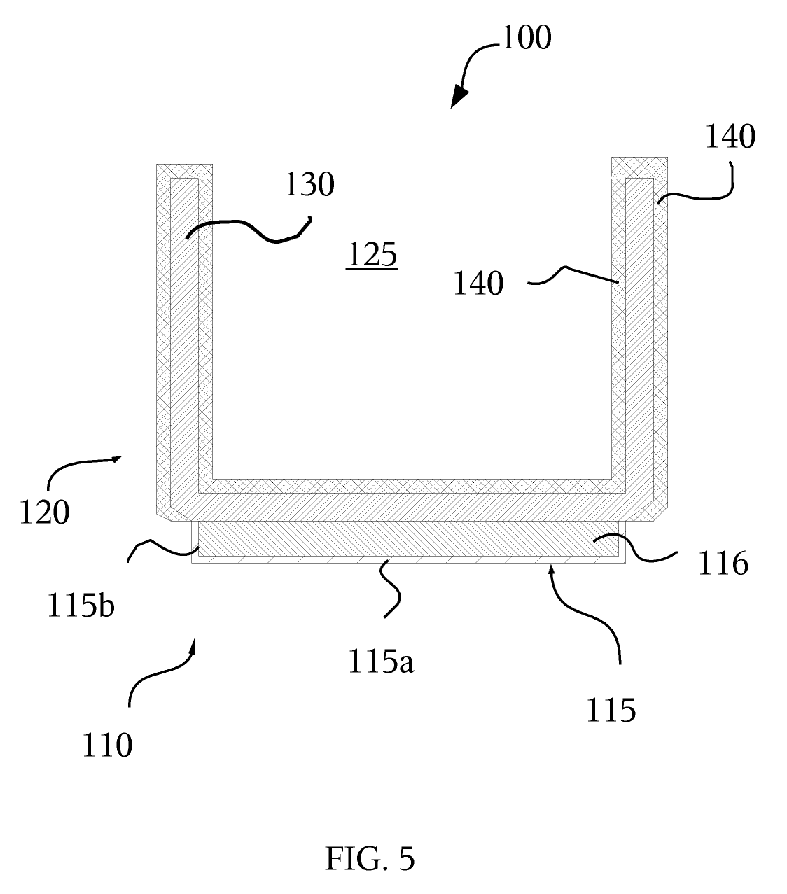

FIG. 5 shows another alternative embodiment of the invention in which the exposed outer surfaces of the aluminum shell 130 have an anodized aluminum coating or finish 140 consisting substantially of aluminum oxide or alumina.

It should also be understood that the thermally conductive material 116 might include sub-layers of other ferroelectric materials to optimize the effectiveness as a receptor of energy in induction cooking, as is generally taught in U.S. Pat. No. 4,596,236, which is incorporated herein by reference. Such sub-layers can be either continuous or discrete sub-layers. Further, such sub-layers need not be organized co-planar with the bottom exterior and interior cooking surfaces. For example, such sub-layers might be organized as a plurality of grooves or strips inclined with respect to the exterior and interior cooking surface, as is generally taught in U.S. Pat. No. 4,544,818, which is incorporated herein by reference

It is further contemplated that the stainless steel or other cap 115 that contains at least one ferromagnetic material need not have the same thickness on the bottom 115a and sidewalls 115b, but may have a thicker sidewall portion 115b to act as a thermal insulator from the upstanding sidewalls of the pan with respect to the principle thermal mass that it surrounds.

In summary of the most preferred embodiments, many objectives of the invention are met by anodizing the portion of the aluminum cookware article that is not protected by the steel base, and more preferably, by also coating the anodized surface of the cookware article with a non-stick coating, as described with respect to FIG. 3. The non-stick coating 150 renders the anodized surface 140 dishwasher safe. Further, as the steel base 115 and encapsulated aluminum plate 116 conduct heat away from the burner or range (be it a radiant heating element, a flame or induction coil) when the pan contains foodstuffs the anodized surfaces will generally not heat up sufficiently to damage the non-stick coating on the exterior of the cooking vessel.

In alternative embodiments of the invention, a non-stick coating can be applied to the interior as well as the exterior of the cookware article 100. Likewise, an anodized finish need not be applied to both the interior and exterior, but can be applied to either the interior or the exterior portion of exposed aluminum shell 130.

It should be further appreciated that the thermally conductive material 116 need not be monolithic but may include sub-layers of other materials that are more thermally conductive, such as one or more continuous or discrete sub-layers of copper in an aluminum sheet, as is generally taught in U.S. Pat. No. 5,952,112, which is incorporated herein by reference. Such sub-layers can be either continuous or discrete sub-layers.

While the invention has been described in connection with various preferred embodiments, it is not intended to limit the scope of the invention to the particular form set forth, but on the contrary, it is intended to cover such alternatives, modifications, and equivalents as may be within the spirit and scope of the invention as defined by the appended claims.

1. An article of cookware comprising:
a) a shell having a bottom cooking surface and surrounding sidewalls extending substantially upward therefrom to define a fluid retaining cavity having an interior surface and an exterior surface,
b) a plate of thermally conductive material bonded to the exterior of the bottom cooking surface, said thermally conductive material being at least as thermally conductive as the material that forms said shell,
c) an organic coating substantially covering the exterior portion of the surrounding sidewalls not covered by said plate of thermally conductive material.

2. An article of cookware according to claim 1 and further comprising a cap disposed in thermal communication and surrounding said plate of thermally conductive material, the edge of said cap extending to the exterior of the bottom cooking surface.

3. An article of cookware according to claim 2 wherein at least one of said cap and said plate of thermally conductive material is comprised of a ferromagnetic material.

4. An article of cookware according to claim 2 wherein said cap is less thermally conductive than said plate of thermally conductive material.

5. An article of cookware according to claim 2 wherein said cap is comprised of stainless steel.

6. An article of cookware according to claim 1 wherein said thermally conductive material comprises aluminum.

7. An article of cookware according to claim 6 wherein said shell comprises aluminum or an alloy thereof.

8. An article of cookware according to claim 7 wherein said aluminum shell is anodized on at least one of the interior and exterior surface.

9. An article of cookware according to claim 1 wherein said protective organic coating is a non-stick coating.

10. An article of cookware according to claim 8 wherein said protective organic coating is a non-stick coating.

11. An article of cookware according to claim 8 wherein said thermally conductive material comprises at least one of aluminum and copper.

12. An article of cookware according to claim 5 wherein the stainless steel that comprises said cap has a thickness of less than about 1 mm.

13. An article of cookware according to claim 3 wherein said thermally conductive material consists essentially of aluminum.

14. An article of cookware according to claim 11 wherein said thermally conductive aluminum plate surrounded by said cap has a thickness of at least about 2 mm.

15. An article of cookware according to claim 11 wherein said thermally conductive aluminum plate surrounded by said cap has a thickness of at least about 5 mm.

16. An article of cookware according to claim 11 wherein said thermally conductive aluminum plate surrounded by said cap has a thickness of at least about 7 mm.

17. An article of cookware according to claim 7 wherein the combined thickness of said thermally conductive aluminum plate and said aluminum shell at the bottom cooking surface is at least about two times the thickness of said aluminum shell.

18. An article of cookware according to claim 3 wherein the combined thickness of said thermally conductive aluminum plate and said aluminum shell at the bottom cooking surface is at least about three times the thickness of said aluminum shell.

19. An article of cookware according to claim 1 and further comprising at least one layer of a magnetic material beneath the interior bottom cooking surface of said shell.

20. An article of cookware according to claim 19 wherein the magnetic material is a grating structure.

21. An article of cookware according to claim 20 wherein the holes that comprise the grating have protrusions that penetrate at least one of the surrounding materials to mechanically interlock therewith.

22. An article of cookware comprising:
a) a shell having a bottom cooking surface and surrounding sidewalls extending substantially upward there from to define a fluid retaining cavity having an interior surface and an exterior surface,
b) an organic coating substantially covering the exterior portion of the surrounding sidewalls not covered by said plate of thermally conductive material.
c) a base disposed on the bottom exterior of said shell for supporting the cookware article on a cooking range or stovetop whereby said organic coating is spaced away form the cooking range so as to avoid the thermal degradation thereof.

23. An article of cookware according to claim 22 wherein said base comprises a ferromagnetic material for induction cooking.

24. An article of cookware according to claim 22 wherein said base comprises a material at least as thermally conductive as said shell.

25. An article of cookware according to claim 23 wherein said base comprises a material at least as thermally conductive as said shell.

26. An article of cookware according to claim 23 wherein said ferromagnetic materials is an exterior cap around said base.

27. An article of cookware according to claim 23 wherein said ferromagnetic materials is a grating connecting said base to said shell.

28. An article of cookware according to claim 24 wherein an exterior stainless steel cap surrounds said base.

29. An article of cookware according to claim 28 wherein the exterior stainless steel cap is ferromagnetic.

30. An article of cookware according to claim 29 wherein the thermally conductive material is aluminum.

31. An article of cookware according to claim 30 wherein the shell has at least a portion of the interior and exterior surface that is anodized aluminum.

32. An article of cookware comprising:
a) An aluminum shell having a bottom cooking surface and surrounding sidewalls extending substantially upward there from to define a fluid retaining cavity having an interior surface and an exterior surface,
b) a plate of thermally conductive material bonded to the exterior of the bottom cooking surface, the thermally conductive material being at least as thermally conductive as the material that forms said shell,
c) a protective cap disposed in thermal communication and surrounding said plate of thermally conductive material, the edge of the cap extending to the exterior of the bottom cooking surface,
d) wherein at least of one the interior and exterior exposed surfaces of the shell has an anodized finish.

33. An article of cookware according to claim 21 wherein both the interior and exterior exposed surfaces of the shell have an anodized finish.

34. An article of cookware according to claim 22 and wherein the assembly of said cap and said plate of thermally conductive material comprises at least one ferromagnetic material.

35. An article of cookware according to claim 22 wherein the ferromagnetic material is stainless steel.

36. An article of cookware according to claim 22 wherein the cap is ferromagnetic material is stainless steel.
